(19) United States
(12) Patent Application Publication
(10) Pub. No.: US 2026/0208123 A1
(43) Pub. Date: Jul. 23, 2026

(54) METHOD FOR MAKING CROSS-LINKABLE ZWITTERIONIC POLYMER MEMBRANES AND THEIR USE

(71) Applicant: Trustees of Tufts College, Medford, MA (US)

(72) Inventors: Samuel J. Lounder, Somerville, MA (US); Ayse Asatekin Alexiou, Arlington, MA (US)

(21) Appl. No.: 19/140,506

(22) PCT Filed: Dec. 22, 2023
(86) PCT No.: PCT/US23/85614

§ 371 Date: Jun. 18, 2025

Related U.S. Application Data
(60) Provisional application No. 63/434,679, filed on Dec. 22, 2022.

(51) Int. Cl. B01D 69/12; B01D 67/00; B01D 71/40; C08F 2/48

(52) U.S. Cl. CPC B01D 69/1214; B01D 67/0006; B01D 67/00091; B01D 69/1216; B01D 69/125; B01D 71/401; C08F 2/48; B01D 2323/30; B01D 2323/345; B01D 2323/40

(57) ABSTRACT

Disclosed is a method of making a thin film composite membrane, the method comprising: providing a copolymer comprising (i) a plurality of zwitterionic repeat units, and (ii) a plurality of hydrophobic repeat units; wherein each hydrophobic repeat unit comprises an alkene; providing a plurality of crosslinking units; wherein each crosslinking unit comprises a first terminal thiol moiety and a second terminal thiol moiety; providing an initiator; providing a solvent; admixing the copolymer, the plurality of crosslinking units, the initiator, and the solvent, thereby forming a mixture; coating the mixture onto a support membrane; evaporating the solvent, activating the initiator, thereby forming the thin film composite membrane comprising a crosslinked zwitterionic copolymer, wherein a mass ratio of the copolymer:the initiator:the plurality of crosslinking units is about 10:1:1 to about 200:1:1.

### RELATED APPLICATIONS

This application claims the benefit of priority to U.S. Provisional Patent Application No. 63/434,679, filed Dec. 22, 2022.

### BACKGROUND

Membrane filtration is an important and promising method of water purification, reclamation and reuse. Membranes of various pore sizes can be used for a wide range of objectives, from simply removing disease-causing microorganisms to desalination by reverse osmosis (RO). Membranes also serve as an efficient, simple, scalable separation method in various industries, such as food, beverage, dairy, and bio/pharmaceutical industries. RO membranes are designed for desalination of sources including brackish water, seawater, groundwater, industrial wastewater, and agricultural wastewater, in addition to the removal of small neutral molecules from these sources. Nanofiltration (NF) membranes are designed for water softening of sources including industrial wastewater, agricultural wastewater, brackish water, seawater, groundwater, as well as removal of small neutral molecules from these sources.

All of the aforementioned membrane processes are often severely impacted by fouling, defined as the degradation of membrane performance due to the adsorption and accumulation of feed components on the membrane surface. Severe declines in membrane permeability and changes in membrane selectivity are common. Fouling management is a significant component of costs associated with membrane systems, requiring increased energy use, regular cleanings involving downtime, maintenance and chemical use, and more complex processes.

### SUMMARY

One aspect of the invention is a scalable manufacturing process for cross-linkable zwitterionic copolymer (XZC) thin film composite (TFC) membranes. Unlike previous approaches to fabricate XZC membranes, the membrane cross-linkers are included in the copolymer/solvent casting solution to allow immediate membrane cross-linking.

A copolymer composed of a hydrophobic cross-linkable monomer and one (or more) zwitterionic monomer(s) is first synthesized. The copolymer and cross-linkers are then dissolved in a solvent and coated onto a support membrane to prepare thin film composite (TFC) membranes. After evaporating the solvent, the membrane is immediately subjected to post-treatment to cross-link membrane. The cross-linking reaction shrinks the selective layer pore size and also confers stability (e.g., solvent and thermal stability) to the membrane selective layer.

Provided herein is a method of making a thin film composite membrane with tunable size based selectivity for small organic molecules and selectivity between dissolved ions.

In an aspect, disclosed is a method of making a thin film composite membrane, the method comprising:
providing a copolymer comprising (i) a plurality of zwitterionic repeat units, and (ii) a plurality of hydrophobic repeat units; wherein each hydrophobic repeat unit comprises an alkene;
providing a plurality of crosslinking units; wherein each crosslinking unit comprises a first terminal thiol moiety and a second terminal thiol moiety;
providing an initiator;
providing a solvent;
admixing the copolymer, the plurality of crosslinking units, the initiator, and the solvent, thereby forming a mixture;
coating the mixture onto a support membrane;
evaporating the solvent,
activating the initiator, thereby forming the thin film composite membrane comprising a crosslinked zwitterionic copolymer,
wherein a mass ratio of the copolymer:the initiator:the plurality of crosslinking units is about 10:1:1 to about 200:1:1.

### BRIEF DESCRIPTION OF THE DRAWINGS

FIG. 1A is a schematic representation of a molecular self-assembly to generate bicontinuous networks of zwitterionic (shown with positive and negative charged groups) and cross-linkable hydrophobic (circles with stripes) domains. Water and smaller solutes can pass through the zwitterionic channels, while larger solutes are retained.

FIG. 1B shows a synthesis scheme of a cross-linkable random zwitterionic copolymer (ZAC) and its cross-linking reaction through thiol-ene click chemistry.

FIG. 1C is a schematic representation of the associated UV assisted cross-linking.

### DETAILED DESCRIPTION

Current RO and NF membranes generally feature polyamide selective layers. These membranes permeate water much faster than certain salt ions (e.g., monovalent ions for RO and divalent ions for NF) when a transmembrane pressure drop is applied to the feed side of the membrane, enabling the rejection of the salt ions. Polyamide membranes suffer from several key technical limitations, including: (1) membrane fouling, defined as the unwanted adsorption of feed components onto the membrane surface, and (2) chlorine sensitivity, defined as the loss or change in performance due to treatment with chlorine (e.g., sodium hypochlorite, calcium hypochlorite). Membrane fouling leads to a loss in membrane permeability, necessitating expensive chemical treatment of the membrane and leading to operational downtime. Chlorine sensitivity prevents facile management of biofouling (the growth of microorganisms on the membrane surface) by exposing the membrane to aqueous solutions of chlorine (hypochlorite). This can necessitate the use of alternative/expensive biocides or complex pretreatment processes instead of directly treating the feed solution with inexpensive chlorine (hypochlorite). Cellulose acetate is another polymeric selective layer used to prepare RO membranes. Cellulose acetate RO membranes suffer from membrane fouling, low water permeability, and pH sensitivity that requires operation within a narrow window of pH. Polyether sulfone is another polymeric selective layer used to prepare NF membranes. Polyether sulfone NF membranes suffer from high fouling propensity and low water flux.

Disclosed herein is a thin film composite (TFC) membrane manufacturing method for use with a particular family of copolymers. This family of copolymers, termed cross-linkable zwitterionic copolymers, comprise at least two types of repeat units:
(1) A cross-linkable monomer. A typical cross-linkable moiety is a C═C double bond, which can be polymerized upon exposure to a free radical photoinitiator, including one activated by ultraviolet (UV) light. It may also be possible to do this using thermal methods (i.e., using an initiator activated at higher temperatures), or through a redox reaction. The cross-linkable moiety may not be C═C double bond and could instead be polymerized by exposure to UV light in the absence of radical initiators.
(2) A zwitterionic monomer, which serves to impart water permeability and fouling resistance to the membrane selective layer.

Some of the copolymers within this family are described in PCT Application No. PCT/US21/32793—CROSS-LINKABLE ZWITTERIONIC POLYMERS AND THEIR USE IN MEMBRANE FILTERS, published as WO 2021/232018, which is incorporated by reference.

This invention enables the scalable manufacture of TFC membranes using cross-linkable zwitterionic copolymers. These membranes can exhibit high salt retention, high small molecule rejection, high protein rejection, tunable pore size, fouling resistance, and chlorine resistance. These membranes can perform a range of salt separations, including but not limited to desalination, water softening, and selective ion separations. These membranes can also perform a range of small molecule/macromolecule separations with sources such as industrial wastewater, brackish water, seawater, groundwater, and aqueous feedstocks generated in various bioprocessing applications. The membranes described have effective pore sizes typically under about 3 nm, preferably under about 2 nm, and even more preferably under about 1 nm.

To prepare TFC membranes using this invention, one or more types of cross-linkable zwitterionic copolymer are mixed and dissolved with a solvent and at least one additional type of small molecule/macromolecule herein referred to as the Initiator. The Initiator is described as a type of small molecule or macromolecule that initiates a chemical reaction that leads to the cross-linking of the cross-linkable groups of the cross-linkable zwitterionic copolymer. The Initiator can be included at quantities of about 0-20 grams/1 gram of copolymer, preferably about 0-1 grams/1 gram of copolymer, and even more preferably about 0-0.1 grams/1 gram of copolymer. It is possible to also include one or more additional type of small molecule/macromolecule herein referred to as an Accelerator or a plurality of crosslinking units. The Accelerator/plurality of crosslinking units is described as a small molecule/macromolecule that also participate in this cross-linking reaction and leads to enhanced reaction rates, conversions, or other improvements. The Accelerator/plurality of crosslinking units can be included at quantities of about 0-20 grams/1 gram of copolymer, preferably about 0-1 grams/1 gram of copolymer, and even more preferably about 0-0.1 grams/1 gram of copolymer.

In an embodiment, 2-hydroxy-2-methylpropiophenone is used as an Initiator. Other examples of Initiators are: (1) photo-initiators, i.e., Initiators that generate radicals upon exposure to UV light. Examples of this include but not limited to benzoin ethers, benzil ketals, α-dialkoxy-acetophenones, α-hydroxyl-alkyl-phenones, α-amino-alkyl-phenones, acyl-phosphine oxides, benzophenones (with or without amine synergist included), and thioxanthones (with or without amine synergist included). (2) redox initiators, i.e., Initiators that generate radicals through reduction/oxidation (i.e., “redox”) reactions with or without additional chemical reagents. Examples of redox initiators include but are not limited to hydrogen peroxide, alkyl peroxides, acyl peroxides, persulfates, disulfides, and dibenzoyl peroxide (used with or without tertiary amine synergists). (3) thermal initiators, i.e., Initiators that generate radicals at elevated temperatures. These include but are not limited to benzoyl peroxide, 1,1′-azobis(cyclohexanecarbonitrile), azobisisobutyronitrile, and di-tert-butyl nitroxide. In an embodiment, 1,6-hexane dithiol is used as the Accelerator ot the plurality of crosslinking units. Other examples include alkyl dithiols, benzene dithiols, ethylene glycol dithiols, biphenyl dithiols, multiarmed thiols (e.g., Tetra(ethylene glycol) dithiol), mono-thiols, and polymers/copolymers that contain thiols (e.g., poly(ethylene glycol) dithiol).

Disclosed herein is the preparation of TFC membranes by coating a solution of copolymer, Initiator, solvent, and possibly also Accelerator/plurality of crosslinking units onto a porous support by methods well-understood in the membrane industry (e.g., doctor blade coating, spray coating). Through chemical reactions involving the copolymer, the Initiator, and potentially also the Accelerator/plurality of crosslinking units, the cross-linkable groups on the copolymer chains are activated to form additional bonds between them. In an embodiment, this is done by activating the Initiator with some external exposure (e.g., UV light, elevated temperate) immediately after coating, i.e., before any appreciable amount of solvent has been lost. In a an embodiment, this is done by first removing the solvent through methods well-understood in the membrane industry (e.g., evaporation or use of a coagulation bath) to solidify the copolymer selective layer. In this embodiment, the Initiator and Accelerator will not be removed substantially with the solvent and will remain dissolved in/in contact with the solid copolymer selective layer. In this embodiment, the copolymer selective layer is then cross-linked by some external exposure (e.g., UV light, elevated temperate) immediately after the removal of the selective layer. For instance, the solvent could be removed by evaporative drying in an oven, followed by cross-linking with UV light immediately after the oven drying stage.

This invention allows the scalable manufacture of thin film composite (TFC) membranes, comprising at least two layers: A porous support with large pores, providing mechanical integrity, and a thin (preferably <10 μm, more preferably <3 μm, even more preferably <1 μm) layer of the cross-linked copolymer, serving as the “selective layer” of the membrane. In this particular embodiment, the copolymer layer should contain a continuous dense layer of copolymer (i.e., not regular “through-pores” providing pathways for water permeation, with the exception of unintended and occasional defects that may appear in processing even if they are not desired). In other words, water should permeate through the copolymer, rather than pores/holes in it, as the main transport mechanism. Upon deposition, the zwitterionic and ionic/ionizable groups are expected to form clusters due to Coulombic interactions. These clusters will serve as ionic nanochannels that permeate water. The copolymer will be intentionally cross-linked as described above.

In one aspect, disclosed is a method of making a thin film composite membrane, comprising:
providing a copolymer comprising (i) a plurality of zwitterionic repeat units, and (ii) a plurality of hydrophobic repeat units; wherein each hydrophobic repeat unit comprises an alkene;
providing a plurality of crosslinking units; wherein each crosslinking unit comprises a first terminal thiol moiety and a second terminal thiol moiety;
providing an initiator;
providing a solvent;
admixing the copolymer, the plurality of crosslinking units, the initiator, and the solvent, thereby forming a mixture;
coating the mixture onto a support membrane;
evaporating the solvent,
activating the initiator, thereby forming the thin film composite membrane comprising a crosslinked zwitterionic copolymer,
wherein a mass ratio of the copolymer:the initiator:the plurality of crosslinking units is about 10:1:1 to about 200:1:1.

In certain embodiments, the solvent is methanol, acetonitrile, isopropanol, hexane, or a combination of any of them. In certain embodiments, the activation is performed at a room temperature.

In certain embodiments, the initiator is a photo-initiator, redox initiator, thermal initiator, or a combination of any of them. In certain embodiments, the initiator is a benzoin ether, a benzil ketal, a α-dialkoxy-acetophenone, a α-hydroxyl-alkyl-phenone, a α-amino-alkyl-phenone, an acyl-phosphine oxide, a benzophenone (with or without amine synergist), a thioxanthone (with or without amine synergist), hydrogen peroxide, an alkyl peroxide, an acyl peroxide, a persulfate, a disulfide, a dibenzoyl peroxide (with or without tertiary amine synergists), a benzoyl peroxide, 1,1′-azobis(cyclohexanecarbonitrile), azobisisobutyronitrile, di-tert-butyl nitroxide, or a combination thereof. In certain embodiments, the initiator is 2,2-dimethoxy-2-phenylacetophenone (DPMA) or 2-hydroxy-2-methylpropiophenone.

In certain embodiments, the crosslinking unit is an alkyl dithiol, a benzene dithiol, an ethylene glycol dithiol, a biphenyl dithiol, a multiarmed thiol (e.g., tetra(ethylene glycol) dithiol), a mono-thiol, or a polymer or a copolymer that include thiols (e.g., poly(ethylene glycol) dithiol). In certain embodiments, the crosslinking unit is 1,6-hexanedithiol (HDT). In certain embodiments, the solvent is a mixture of methanol and acetonitrile. In certain embodiments, methanol and acetonitrile are present in about 1.5:1 to about 3:1 ratio (v/v) at about 4 to about 6 w/v %. In certain embodiments, methanol and acetonitrile are present in about 1.5:1 ratio (v/v) at about 4.4 to about 4.6 w/v %. In certain embodiments, methanol and acetonitrile are present in about 3:1 ratio (v/v) at about 5 w/v %.

In certain embodiments, the mass ratio of the copolymer:the initiator:plurality of crosslinking units is about 10:1:1 to about 100:1:1. In certain embodiments, the mass ratio of the copolymer:the initiator:plurality of crosslinking units is about 100:1:1 to about 200:1:1 In certain embodiments, the mass ratio of the copolymer:the initiator:plurality of crosslinking units is about 10:1:1.

In certain embodiments, the amount of the initiator is 0.01 grams to about 20 grams per gram of the copolymer. In certain embodiments, the amount of the initiator is about 0.1 grams to about 1 grams per gram of the copolymer. In certain embodiments, the amount of the initiator is 0.01 grams to about 0.1 grams per gram of the copolymer.

In certain embodiments, the amount of the plurality of crosslinking units is 0.01 grams to about 20 grams per gram of the copolymer. In certain embodiments, the amount of the plurality of crosslinking units is about 0.1 grams to about 1 grams per gram of the copolymer. In certain embodiments, the amount of the plurality of crosslinking units is 0.01 grams to about 0.1 grams per gram of the copolymer.

In certain embodiments, the support membrane comprises UE50, Trisep, or a combination thereof. In certain embodiments, the mixture is coated onto the support membrane using a wire wound rod.

In certain embodiments, the solvent is evaporated by heating at about 50-100° C. In certain embodiments, the solvent is evaporated by heating at about 80° C.

In certain embodiments, the initiator is activated with UV light, or an elevated temperature, or a combination thereof. In certain embodiments, the initiator is activated by irradiation with UV light.

In certain embodiments, the irradiation is performed for about 10 seconds to about 150 seconds. In certain embodiments, the irradiation is performed for about 30 seconds. In certain embodiments, the irradiation is performed for about 60 seconds. In certain embodiments, the irradiation is performed for about 90 seconds. In certain embodiments, the irradiation is performed for about 120 seconds.

In certain embodiments, the thin film composite membrane comprises at least two layers of a porous support layer, and a layer of the crosslinked zwitterionic copolymer. In certain embodiments, the layer of the crosslinked zwitterionic copolymer has a thickness of about 0.1 μm to about 10 μm. In certain embodiments, the layer of the crosslinked zwitterionic copolymer has a thickness of about 1 μm to about 10 μm.

### Definitions

Unless otherwise defined herein, scientific and technical terms used in this application shall have the meanings that are commonly understood by those of ordinary skill in the art. Generally, nomenclature used in connection with, and techniques of, chemistry, cell and tissue culture, molecular biology, cell and cancer biology, neurobiology, neurochemistry, virology, immunology, microbiology, pharmacology, genetics and protein and nucleic acid chemistry, described herein, are those well-known and commonly used in the art.

The methods and techniques of the present disclosure are generally performed, unless otherwise indicated, according to conventional methods well known in the art and as described in various general and more specific references that are cited and discussed throughout this specification. See, e.g. “Principles of Neural Science”, McGraw-Hill Medical, New York, N.Y. (2000); Motulsky, “Intuitive Biostatistics”, Oxford University Press, Inc. (1995); Lodish et al., “Molecular Cell Biology, 4th ed.”, W. H. Freeman & Co., New York (2000); Griffiths et al., “Introduction to Genetic Analysis, 7th ed.”, W. H. Freeman & Co., N.Y. (1999); and Gilbert et al., “Developmental Biology, 6th ed.”, Sinauer Associates, Inc., Sunderland, MA (2000).

Chemistry terms used herein, unless otherwise defined herein, are used according to conventional usage in the art, as exemplified by “The McGraw-Hill Dictionary of Chemical Terms”, Parker S., Ed., McGraw-Hill, San Francisco, C.A. (1985).

As used herein, the terms “optional” or “optionally” mean that the subsequently described event or circumstance may occur or may not occur, and that the description includes instances where the event or circumstance occurs as well as instances in which it does not. For example, “optionally substituted alkyl” refers to the alkyl may be substituted as well as where the alkyl is not substituted.

It is understood that substituents and substitution patterns on the compounds of the present invention can be selected by one of ordinary skilled person in the art to result chemically stable compounds which can be readily synthesized by techniques known in the art, as well as those methods set forth below, from readily available starting materials. If a substituent is itself substituted with more than one group, it is understood that these multiple groups may be on the same carbon or on different carbons, so long as a stable structure results.

As used herein, the term “optionally substituted” refers to the replacement of one to six hydrogen radicals in a given structure with the radical of a specified substituent including, but not limited to: hydroxyl, hydroxyalkyl, alkoxy, halogen, alkyl, nitro, silyl, acyl, acyloxy, aryl, cycloalkyl, heterocyclyl, amino, aminoalkyl, cyano, haloalkyl, haloalkoxy, —OCO—CH₂—O-alkyl, —OP(O)(O-alkyl)₂ or —CH₂—OP(O)(O-alkyl)₂. Preferably, “optionally substituted” refers to the replacement of one to four hydrogen radicals in a given structure with the substituents mentioned above. More preferably, one to three hydrogen radicals are replaced by the substituents as mentioned above. It is understood that the substituent can be further substituted.

Articles such as “a,” “an,” and “the” may mean one or more than one unless indicated to the contrary or otherwise evident from the context. Claims or descriptions that include “or” between one or more members of a group are considered satisfied if one, more than one, or all of the group members are present in, employed in, or otherwise relevant to a given product or process unless indicated to the contrary or otherwise evident from the context. The invention includes embodiments in which exactly one member of the group is present in, employed in, or otherwise relevant to a given product or process. The invention includes embodiments in which more than one, or all of the group members are present in, employed in, or otherwise relevant to a given product or process.

As used herein, the term “alkyl” refers to saturated aliphatic groups, including but not limited to C₁-C₁₀ straight-chain alkyl groups or C₁-C₁₀ branched-chain alkyl groups. Preferably, the “alkyl” group refers to C₁-C₆ straight-chain alkyl groups or C₁-C₆ branched-chain alkyl groups. Most preferably, the “alkyl” group refers to C₁-C₄ straight-chain alkyl groups or C₁-C₄ branched-chain alkyl groups. Examples of “alkyl” include, but are not limited to, methyl, ethyl, 1-propyl, 2-propyl, n-butyl, sec-butyl, tert-butyl, 1-pentyl, 2-pentyl, 3-pentyl, neo-pentyl, 1-hexyl, 2-hexyl, 3-hexyl, 1-heptyl, 2-heptyl, 3-heptyl, 4-heptyl, 1-octyl, 2-octyl, 3-octyl or 4-octyl and the like. The “alkyl” group may be optionally substituted.

The term “acyl” is art-recognized and refers to a group represented by the general formula hydrocarbylC(O)—, preferably alkylC(O)—.

The term “acylamino” is art-recognized and refers to an amino group substituted with an acyl group and may be represented, for example, by the formula hydrocarbylC(O) NH—.

The term “acyloxy” is art-recognized and refers to a group represented by the general formula hydrocarbylC(O)O—, preferably alkylC(O)O—.

The term “alkoxy” refers to an alkyl group having an oxygen attached thereto. Representative alkoxy groups include methoxy, ethoxy, propoxy, tert-butoxy and the like.

The term “alkoxyalkyl” refers to an alkyl group substituted with an alkoxy group and may be represented by the general formula alkyl-O-alkyl.

The term “alkyl” refers to saturated aliphatic groups, including straight-chain alkyl groups, branched-chain alkyl groups, cycloalkyl (alicyclic) groups, alkyl-substituted cycloalkyl groups, and cycloalkyl-substituted alkyl groups. In preferred embodiments, a straight chain or branched chain alkyl has 30 or fewer carbon atoms in its backbone (e.g., C₁₋₃₀ for straight chains, C₃₋₃₀ for branched chains), and more preferably 20 or fewer.

Moreover, the term “alkyl” as used throughout the specification, examples, and claims is intended to include both unsubstituted and substituted alkyl groups, the latter of which refers to alkyl moieties having substituents replacing a hydrogen on one or more carbons of the hydrocarbon backbone, including haloalkyl groups such as trifluoromethyl and 2,2,2-trifluoroethyl, etc.

The term “C_{x-y}” or “Cₓ-C_{y}”, when used in conjunction with a chemical moiety, such as, acyl, acyloxy, alkyl, alkenyl, alkynyl, or alkoxy is meant to include groups that contain from x to y carbons in the chain. C₀alkyl indicates a hydrogen where the group is in a terminal position, a bond if internal. A C₁₋₆alkyl group, for example, contains from one to six carbon atoms in the chain.

The term “alkylamino”, as used herein, refers to an amino group substituted with at least one alkyl group.

The term “alkylthio”, as used herein, refers to a thiol group substituted with an alkyl group and may be represented by the general formula alkylS—.

The term “amide”, as used herein, refers to a group

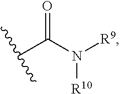

wherein R⁹ and R¹⁰ each independently represent a hydrogen or hydrocarbyl group, or R⁹ and R¹⁰ taken together with the N atom to which they are attached complete a heterocycle having from 4 to 8 atoms in the ring structure.

The terms “amine” and “amino” are art-recognized and refer to both unsubstituted and substituted amines and salts thereof, e.g., a moiety that can be represented by

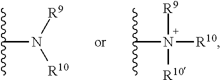

wherein R⁹, R¹⁰, and R¹⁰′ each independently represent a hydrogen or a hydrocarbyl group, or R⁹ and R¹⁰ taken together with the N atom to which they are attached complete a heterocycle having from 4 to 8 atoms in the ring structure.

The term “aminoalkyl”, as used herein, refers to an alkyl group substituted with an amino group.

The term “aralkyl”, as used herein, refers to an alkyl group substituted with an aryl group.

The term “aryl” as used herein include substituted or unsubstituted single-ring aromatic groups in which each atom of the ring is carbon. Preferably the ring is a 5- to 7-membered ring, more preferably a 6-membered ring. The term “aryl” also includes polycyclic ring systems having two or more cyclic rings in which two or more carbons are common to two adjoining rings wherein at least one of the rings is aromatic, e.g., the other cyclic rings can be cycloalkyls, cycloalkenyls, cycloalkynyls, aryls, heteroaryls, and/or heterocyclyls. Aryl groups include benzene, naphthalene, phenanthrene, phenol, aniline, and the like.

The term “carbamate” is art-recognized and refers to a group

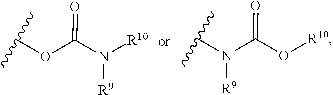

wherein R⁹ and R¹⁰ independently represent hydrogen or a hydrocarbyl group.

The term “carbocyclylalkyl”, as used herein, refers to an alkyl group substituted with a carbocycle group.

The term “carbocycle” includes 5-7 membered monocyclic and 8-12 membered bicyclic rings. Each ring of a bicyclic carbocycle may be selected from saturated, unsaturated and aromatic rings. Carbocycle includes bicyclic molecules in which one, two or three or more atoms are shared between the two rings. The term “fused carbocycle” refers to a bicyclic carbocycle in which each of the rings shares two adjacent atoms with the other ring. Each ring of a fused carbocycle may be selected from saturated, unsaturated and aromatic rings. In an exemplary embodiment, an aromatic ring, e.g., phenyl, may be fused to a saturated or unsaturated ring, e.g., cyclohexane, cyclopentane, or cyclohexene. Any combination of saturated, unsaturated and aromatic bicyclic rings, as valence permits, is included in the definition of carbocyclic. Exemplary “carbocycles” include cyclopentane, cyclohexane, bicyclo[2.2.1]heptane, 1,5-cyclooctadiene, 1,2,3,4-tetrahydronaphthalene, bicyclo[4.2.0]oct-3-ene, naphthalene and adamantane. Exemplary fused carbocycles include decalin, naphthalene, 1,2,3,4-tetrahydronaphthalene, bicyclo[4.2.0]octane, 4,5,6,7-tetrahydro-1H-indene and bicyclo[4.1.0]hept-3-ene. “Carbocycles” may be substituted at any one or more positions capable of bearing a hydrogen atom.

The term “carbocyclylalkyl”, as used herein, refers to an alkyl group substituted with a carbocycle group.

The term “carbonate” is art-recognized and refers to a group —OCO₂—.

The term “carboxy”, as used herein, refers to a group represented by the formula —CO₂H.

The term “ester”, as used herein, refers to a group —C(O)OR⁹ wherein R⁹ represents a hydrocarbyl group.

The term “ether”, as used herein, refers to a hydrocarbyl group linked through an oxygen to another hydrocarbyl group. Accordingly, an ether substituent of a hydrocarbyl group may be hydrocarbyl-O—. Ethers may be either symmetrical or unsymmetrical. Examples of ethers include, but are not limited to, heterocycle-O-heterocycle and aryl-O-heterocycle. Ethers include “alkoxyalkyl” groups, which may be represented by the general formula alkyl-O-alkyl.

The terms “halo” and “halogen” as used herein means halogen and includes chloro, fluoro, bromo, and iodo.

The terms “hetaralkyl” and “heteroaralkyl”, as used herein, refers to an alkyl group substituted with a hetaryl group.

The terms “heteroaryl” and “hetaryl” include substituted or unsubstituted aromatic single ring structures, preferably 5- to 7-membered rings, more preferably 5- to 6-membered rings, whose ring structures include at least one heteroatom, preferably one to four heteroatoms, more preferably one or two heteroatoms. The terms “heteroaryl” and “hetaryl” also include polycyclic ring systems having two or more cyclic rings in which two or more carbons are common to two adjoining rings wherein at least one of the rings is heteroaromatic, e.g., the other cyclic rings can be cycloalkyls, cycloalkenyls, cycloalkynyls, aryls, heteroaryls, and/or heterocyclyls. Heteroaryl groups include, for example, pyrrole, furan, thiophene, imidazole, oxazole, thiazole, pyrazole, pyridine, pyrazine, pyridazine, and pyrimidine, and the like.

The term “heteroatom” as used herein means an atom of any element other than carbon or hydrogen. Preferred heteroatoms are nitrogen, oxygen, and sulfur.

The term “heterocyclylalkyl”, as used herein, refers to an alkyl group substituted with a heterocycle group.

The terms “heterocyclyl”, “heterocycle”, and “heterocyclic” refer to substituted or unsubstituted non-aromatic ring structures, preferably 3- to 10-membered rings, more preferably 3- to 7-membered rings, whose ring structures include at least one heteroatom, preferably one to four heteroatoms, more preferably one or two heteroatoms. The terms “heterocyclyl” and “heterocyclic” also include polycyclic ring systems having two or more cyclic rings in which two or more carbons are common to two adjoining rings wherein at least one of the rings is heterocyclic, e.g., the other cyclic rings can be cycloalkyls, cycloalkenyls, cycloalkynyls, aryls, heteroaryls, and/or heterocyclyls. Heterocyclyl groups include, for example, piperidine, piperazine, pyrrolidine, morpholine, lactones, lactams, and the like.

The term “hydrocarbyl”, as used herein, refers to a group that is bonded through a carbon atom that does not have a ═O or ═S substituent, and typically has at least one carbon-hydrogen bond and a primarily carbon backbone, but may optionally include heteroatoms.

Thus, groups like methyl, ethoxyethyl, 2-pyridyl, and even trifluoromethyl are considered to be hydrocarbyl for the purposes of this application, but substituents such as acetyl (which has a ═O substituent on the linking carbon) and ethoxy (which is linked through oxygen, not carbon) are not. Hydrocarbyl groups include, but are not limited to aryl, heteroaryl, carbocycle, heterocycle, alkyl, alkenyl, alkynyl, and combinations thereof.

The term “hydroxyalkyl”, as used herein, refers to an alkyl group substituted with a hydroxy group.

The term “lower” when used in conjunction with a chemical moiety, such as, acyl, acyloxy, alkyl, alkenyl, alkynyl, or alkoxy is meant to include groups where there are ten or fewer atoms in the substituent, preferably six or fewer. A “lower alkyl”, for example, refers to an alkyl group that contains ten or fewer carbon atoms, preferably six or fewer. In certain embodiments, acyl, acyloxy, alkyl, alkenyl, alkynyl, or alkoxy substituents defined herein are respectively lower acyl, lower acyloxy, lower alkyl, lower alkenyl, lower alkynyl, or lower alkoxy, whether they appear alone or in combination with other substituents, such as in the recitations hydroxyalkyl and aralkyl (in which case, for example, the atoms within the aryl group are not counted when counting the carbon atoms in the alkyl substituent).

The terms “polycyclyl”, “polycycle”, and “polycyclic” refer to two or more rings (e.g., cycloalkyls, cycloalkenyls, cycloalkynyls, aryls, heteroaryls, and/or heterocyclyls) in which two or more atoms are common to two adjoining rings, e.g., the rings are “fused rings”. Each of the rings of the polycycle can be substituted or unsubstituted. In certain embodiments, each ring of the polycycle contains from 3 to 10 atoms in the ring, preferably from 5 to 7.

The term “sulfate” is art-recognized and refers to the group —OSO₃H, or a pharmaceutically acceptable salt thereof.

The term “sulfonamide” is art-recognized and refers to the group represented by the general formulae

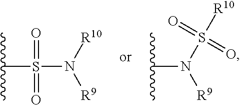

wherein R⁹ and R¹⁰ independently represents hydrogen or hydrocarbyl.

The term “sulfoxide” is art-recognized and refers to the group —S(O)—.

The term “sulfonate” is art-recognized and refers to the group SO₃H, or a pharmaceutically acceptable salt thereof.

The term “sulfone” is art-recognized and refers to the group —S(O)₂—.

The term “substituted” refers to moieties having substituents replacing a hydrogen on one or more carbons of the backbone. It will be understood that “substitution” or “substituted with” includes the implicit proviso that such substitution is in accordance with permitted valence of the substituted atom and the substituent, and that the substitution results in a stable compound, e.g., which does not spontaneously undergo transformation such as by rearrangement, cyclization, elimination, etc. As used herein, the term “substituted” is contemplated to include all permissible substituents of organic compounds. In a broad aspect, the permissible substituents include acyclic and cyclic, branched and unbranched, carbocyclic and heterocyclic, aromatic and non-aromatic substituents of organic compounds. The permissible substituents can be one or more and the same or different for appropriate organic compounds. For purposes of this invention, the heteroatoms such as nitrogen may have hydrogen substituents and/or any permissible substituents of organic compounds described herein which satisfy the valences of the heteroatoms. Substituents can include any substituents described herein, for example, a halogen, a hydroxyl, a carbonyl (such as a carboxyl, an alkoxycarbonyl, a formyl, or an acyl), a thiocarbonyl (such as a thioester, a thioacetate, or a thioformate), an alkoxyl, a phosphoryl, a phosphate, a phosphonate, a phosphinate, an amino, an amido, an amidine, an imine, a cyano, a nitro, an azido, a sulfhydryl, an alkylthio, a sulfate, a sulfonate, a sulfamoyl, a sulfonamido, a sulfonyl, a heterocyclyl, an aralkyl, or an aromatic or heteroaromatic moiety. It will be understood by those skilled in the art that the moieties substituted on the hydrocarbon chain can themselves be substituted, if appropriate.

The term “thioalkyl”, as used herein, refers to an alkyl group substituted with a thiol group.

The term “thioester”, as used herein, refers to a group —C(O)SR⁹ or —SC(O)R⁹
wherein R⁹ represents a hydrocarbyl.

The term “thioether”, as used herein, is equivalent to an ether, wherein the oxygen is replaced with a sulfur.

The term “urea” is art-recognized and may be represented by the general formula

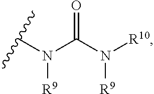

wherein R⁹ and R¹⁰ independently represent hydrogen or a hydrocarbyl.

The term “modulate” as used herein includes the inhibition or suppression of a function or activity (such as cell proliferation) as well as the enhancement of a function or activity.

The phrase “pharmaceutically acceptable” is art-recognized. In certain embodiments, the term includes compositions, excipients, adjuvants, polymers and other materials and/or dosage forms which are, within the scope of sound medical judgment, suitable for use in contact with the tissues of human beings and animals without excessive toxicity, irritation, allergic response, or other problem or complication, commensurate with a reasonable benefit/risk ratio.

“Salt” is used herein to refer to an acid addition salt or a basic addition salt.

Many of the compounds useful in the methods and compositions of this disclosure have at least one stereogenic center in their structure. This stereogenic center may be present in a R or a S configuration, said R and S notation is used in correspondence with the rules described in Pure Appl. Chem. (1976), 45, 11-30. The disclosure contemplates all stereoisomeric forms such as enantiomeric and diastereoisomeric forms of the compounds, salts, prodrugs or mixtures thereof (including all possible mixtures of stereoisomers). See, e.g., WO 01/062726.

Furthermore, certain compounds which contain alkenyl groups may exist as Z (zusammen) or E (entgegen) isomers. In each instance, the disclosure includes both mixture and separate individual isomers.

Some of the compounds may also exist in tautomeric forms. Such forms, although not explicitly indicated in the formulae described herein, are intended to be included within the scope of the present disclosure.

“Solvate” refers to forms of the compound that are associated with a solvent or water (also referred to as “hydrate”), usually by a solvolysis reaction. This physical association includes hydrogen bonding. Conventional solvents include water, ethanol, acetic acid and the like. The compounds of the invention may be prepared e.g., in crystalline form and may be solvated or hydrated. Suitable solvates include pharmaceutically acceptable solvates, such as hydrates, and further include both stoichiometric solvates and non-stoichiometric solvates. In certain instances, the solvate will be capable of isolation, for example when one or more solvent molecules are incorporated in the crystal lattice of the crystalline solid. “Solvate” encompasses both solution-phase and isolable solvates. Representative solvates include hydrates, ethanolates and methanolates.

As used herein, the term “isotopic variant” refers to a compound that contains unnatural proportions of isotopes at one or more of the atoms that constitute such compound. For example, an “isotopic variant” of a compound can contain one or more non-radioactive isotopes, such as for example, deuterium (²H or D), carbon-13 (¹³C), nitrogen-15 (¹⁵N), or the like. It will be understood that, in a compound where such isotopic substitution is made, the following atoms, where present, may vary, so that for example, any hydrogen may be “²H/D, any carbon may be ¹³C, or any nitrogen may be ¹⁵N, and that the presence and placement of such atoms may be determined within the skill of the art. Likewise, the invention may include the preparation of isotopic variants with radioisotopes, in the instance for example, where the resulting compounds may be used for drug and/or substrate tissue distribution studies. The radio-active isotopes tritium, i.e., ³H, and carbon-14, i.e., ¹⁴C, are particularly useful for this purpose in view of their ease of incorporation and ready means of detection. Further, compounds may be prepared that are substituted with positron emitting isotopes, such as ¹¹C, ¹⁸F, ¹⁵O and ¹³N, and would be useful in Positron Emission Topography (PET) studies for examining substrate receptor occupancy. All isotopic variants of the compounds provided herein, radioactive or not, are intended to be encompassed within the scope of the invention.

It is also to be understood that compounds that have the same molecular formula but differ in the nature or sequence of bonding of their atoms or the arrangement of their atoms in space are termed “isomers.” Isomers that differ in the arrangement of their atoms in space are termed “stereoisomers.”

Stereoisomers that are not mirror images of one another are termed “diastereomers” and those that are non-superimposable mirror images of each other are termed “enantiomers.” When a compound has an asymmetric center, for example, it is bonded to four different groups, a pair of enantiomers is possible. An enantiomer can be characterized by the absolute configuration of its asymmetric center and is described by the R- and S-sequencing rules of Cahn and Prelog, or by the manner in which the molecule rotates the plane of polarized light and designated as dextrorotatory or levorotatory (i.e., as (+)- or (−)-isomers, respectively). A chiral compound can exist as either individual enantiomer or as a mixture thereof. A mixture containing equal proportions of the enantiomers is called a “racemic mixture”.

“Tautomers” refer to compounds that are interchangeable forms of a particular compound structure, and that vary in the displacement of hydrogen atoms and electrons. Thus, two structures may be in equilibrium through the movement of it electrons and an atom (usually H). For example, enols and ketones are tautomers because they are rapidly interconverted by treatment with either acid or base. Another example of tautomerism is the aci- and nitro-forms of phenylnitromethane, that are likewise formed by treatment with acid or base. Tautomeric forms may be relevant to the attainment of the optimal chemical reactivity and biological activity of a compound of interest.

As used herein a pure enantiomeric compound is substantially free from other enantiomers or stereoisomers of the compound (i.e., in enantiomeric excess). In other words, an “S” form of the compound is substantially free from the “R” form of the compound and is, thus, in enantiomeric excess of the “R” form. The term “enantiomerically pure” or “pure enantiomer” denotes that the compound comprises more than 95% by weight, more than 96% by weight, more than 97% by weight, more than 98% by weight, more than 98.5% by weight, more than 99% by weight, more than 99.2% by weight, more than 99.5% by weight, more than 99.6% by weight, more than 99.7% by weight, more than 99.8% by weight or more than 99.9% by weight, of the enantiomer. In certain embodiments, the weights are based upon total weight of all enantiomers or stereoisomers of the compound.

As used herein and unless otherwise indicated, the term “enantiomerically pure R-compound” refers to at least about 95% by weight R-compound and at most about 5% by weight S-compound, at least about 99% by weight R-compound and at most about 1% by weight S-compound, or at least about 99.9% by weight R-compound and at most about 0.1% by weight S-compound. In certain embodiments, the weights are based upon total weight of compound.

As used herein and unless otherwise indicated, the term “enantiomerically pure S-compound” or “S-compound” refers to at least about 95% by weight S-compound and at most about 5% by weight R-compound, at least about 99% by weight S-compound and at most about 1% by weight R-compound or at least about 99.9% by weight S-compound and at most about 0.1% by weight R-compound. In certain embodiments, the weights are based upon total weight of compound.

In the compositions provided herein, an enantiomerically pure compound or a pharmaceutically acceptable salt, solvate, hydrate or prodrug thereof can be present with other active or inactive ingredients. For example, a pharmaceutical composition comprising enantiomerically pure R-compound can comprise, for example, about 90% excipient and about 10% enantiomerically pure R-compound. In certain embodiments, the enantiomerically pure R-compound in such compositions can, for example, comprise, at least about 95% by weight R-compound and at most about 5% by weight S-compound, by total weight of the compound. For example, a pharmaceutical composition comprising enantiomerically pure S-compound can comprise, for example, about 90% excipient and about 10% enantiomerically pure S-compound. In certain embodiments, the enantiomerically pure S-compound in such compositions can, for example, comprise, at least about 95% by weight S-compound and at most about 5% by weight R-compound, by total weight of the compound. In certain embodiments, the active ingredient can be formulated with little or no excipient or carrier.

The compounds of this invention may possess one or more asymmetric centers; such compounds can therefore be produced as individual (R)- or (S)-stereoisomers or as mixtures thereof.

Unless indicated otherwise, the description or naming of a particular compound in the specification and claims is intended to include both individual enantiomers and mixtures, racemic or otherwise, thereof. The methods for the determination of stereochemistry and the separation of stereoisomers are well-known in the art.

One having ordinary skill in the art of organic synthesis will recognize that the maximum number of heteroatoms in a stable, chemically feasible heterocyclic ring, whether it is aromatic or non-aromatic, is determined by the size of the ring, the degree of unsaturation and the valence of the heteroatoms. In general, a heterocyclic ring may have one to four heteroatoms so long as the heteroaromatic ring is chemically feasible and stable.

### EXAMPLES

In order that the invention described herein may be more fully understood, the following examples are set forth. The examples described in this application are offered to illustrate the compounds, compositions, materials, device, and methods provided herein and are not to be construed in any way as limiting their scope.

### Materials

Sulfobetaine methacrylate (SBMA, 95%), 2-Methacryloyloxyethyl phosphorylcholine (MPC, 97%), 2,2,2-Trifluoroethyl methacrylate (TFEMA), 2,2-Dimethoxy-2-phenylacetophenone (DMPA, 99%), N,N,N′,N″,N″-pentamethyldiethylenetriamine (PMDETA, 99%), 1,6-Hexanedithiol (≥97%, FG), α-ethyl bromoisobutyrate (EBIB, 98%), CuBr2 (99%), Sodium sulphate, Acid blue 45, Brilliant blue R, Chicago sky blue 6B, Direct red 80, Methyl orange, Ethyl orange and activated aluminum oxide (basic, Brockmann I, standard grade) were purchased from Sigma-Aldrich. Allyl methacrylate (AMA, ≥98.0%), methanol (≥99.8%), acetonitrile (≥99.5%), isopropyl alcohol (IPA, 99.5%), trifluoroethanol (TFE, ≥99.0%) sodium chloride (ACS certified), ethanol and riboflavin (98%), were purchased from Fisher scientific. Vitamin B12 was purchased from MP Biomedicals. Hexane was obtained from VWR. d4-Methanol (99.5%) and d6-DMSO (99.5%) was purchased from Cambridge Isotope Laboratories Inc. Ascorbic acid was purchased from GBiosciences. Commercial nanofiltration membrane NP-30 (permeance: 1.75 LMH/b) was obtained from Sterlitech. UE-50, the ultrafiltration support membrane was obtained from Sterlitech membranes. PS-35, the ultrafiltration support membrane, was obtained from Solecta membranes.

### Example 1. Polymer Synthesis

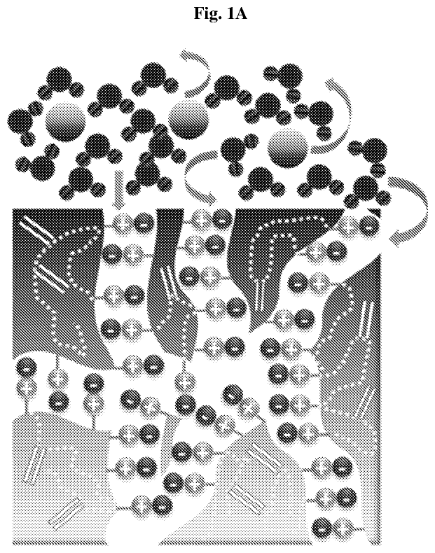

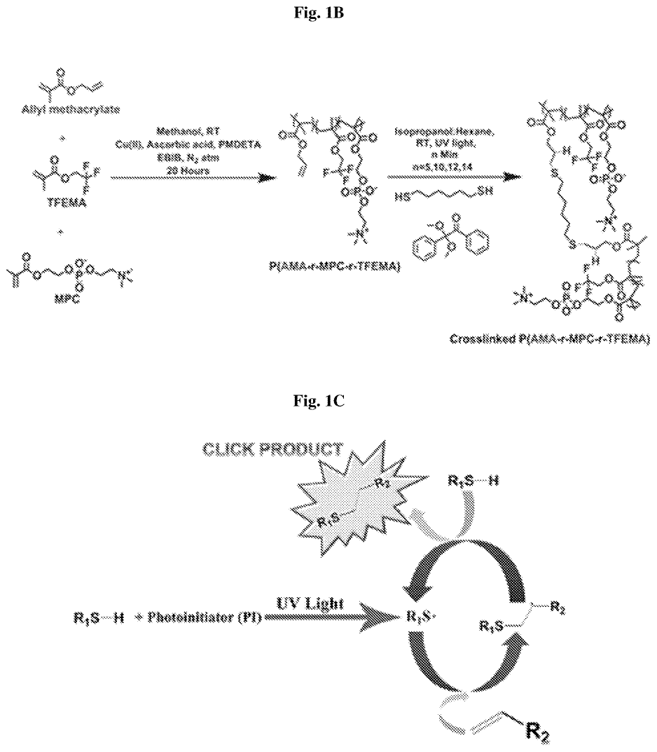

Random copolymers of TFEMA and MPC microphase separate to form a network of ~1.3 nm disordered bicontinuous domains (Bengani-Lutz, et al., Self-Assembling Zwitterionic Copolymers as Membrane Selective Layers with Excellent Fouling Resistance: Effect of Zwitterion Chemistry. ACS Applied Materials & Interfaces 9, 20859-20872, (2017)). Copolymers of AMA and a similar zwitterionic monomer, sulfobetaine methacrylate (SBMA), also formed a very similar morphology (Lounder, et al., Zwitterionic Ion-Selective Membranes with Tunable Subnanometer Pores and Excellent Fouling Resistance. Chemistry of Materials 33, 4408-4416, (2021)). Therefore, it was expected that upon casting, P (AMA-r-TFEMA-r-MPC) will self-assemble to form a similar morphology, resulting in a network of MPC-rich nanodomains that allow the permeation of water and solutes small enough to fit into these “nanochannels”, held together by the hydrophobic TFEMA/AMA-rich domains (FIG. 1A).

### P(AM-r-SBMA-r-MPC)

Copolymers of allyl methacrylate (AMA or AM), sulfobetaine methacrylate (SBMA), and 2-methacryloyloxyethyl phosphorylcholine (MPC) were synthesized by Activators ReGenerated by Electron Transfer Atom Transfer Radical Polymerization (ARGET-ATRP). The reaction solution was 60 wt % AMA, 20 wt % SBMA, and 20 wt % MPC.

### P(AM-r-TFEMA-r-MPC)

The statistical/random copolymer represented here is a combination of three different monomers: 2-methacryloyloxyethyl phosphorylcholine (MPC), a zwitterionic monomer; trifluoroethyl methacrylate (TFEMA), a highly hydrophobic monomer; and allyl methacrylate (AM), a hydrophobic monomer that has a C—C double bond that can readily can undergo thiol-ene click reactions (FIG. 1B). The double bonds present in the AMA units can be crosslinked through a thiol-ene click reaction in presence of a dithiol (FIG. 1B). Thiol-ene “click” chemistry is characterized by very high reaction rates, high conversions and selective yields. These features make it a good choice for post-functionalization of membranes in roll-to-roll systems, where short residence times with high yields are required. Reaction mechanisms of this reaction tolerate the incorporation of a wide range of functionalities with high reliability on time scales aligned with membrane manufacturing rates.

This cross-linking reaction is performed in a solvent that preferentially partitions into the hydrophobic domains, but not the zwitterionic domains. The solvent also plasticizes the TFEMA/AMA domains, increasing the mobility of functional groups sufficiently to enable cross-linking reactions. The cross-linked hydrophobic domains are more rigid, and restrict the swelling of zwitterionic domains when immersed in water. Hence, it leads to smaller effective pore sizes in the cross-linked ZAC-based membrane than un-crosslinked copolymer selective layers in water. Afterwards, the membrane was exposed to UV light for various time periods ranging 10-40 s. During UV curing, DMPA acted as a photoinitiator and generated radicals on 1,6-hexanedithiol, which then reacted with the allylic double bonds of AM repeat units (FIG. 1C).

### Example 2. Bench Scale Membrane Fabrication

TFC membranes were prepared using the copolymer described above. The copolymer and the cross-linkers were first dissolved in a mixture of methanol and acetonitrile (3:1 v:v ratio) at 5.0 w/v % (i.e., 5 g polymer/95 mL solvent). The cross-linkers were 2,2-dimethoxy-2-phenylacetophenone (DPMA) and 1,6-hexanedithiol (HDT) (10:1:1 copolymer:DMPA:HDT mass ratio). The solution was then passed through a syringe filter and coated onto a support membrane (UE50, Trisep) using a wire wound rod (Gardo, No. 16 wire size). The coated membrane was then transferred to an 80° C. convection oven to evaporate the solvent. The cross-linkers are expected to not evaporate in the oven and thereby be uniformly distributed throughout the dried copolymer selective layer following the solvent evaporation. UV light (365 nm) was then shined on the entire membrane sheet to initiate the cross-linking reaction.

### Example 3. Pilot Scale Membrane Manufacturing

TFC membranes were prepared using the copolymer described above. The copolymer and the cross-linkers were first dissolved in a mixture of methanol and acetonitrile (1.5:1 v:v ratio) at 4.4-4.6 w/v % (i.e., 4.4-4.6 g polymer/95 mL solvent). The cross-linkers were 2,2-dimethoxy-2-phenylacetophenone (DPMA) and 1,6-hexanedithiol (HDT) (100:1:1 and 200:1:1 copolymer:DMPA:HDT mass ratios were explored). A given solution was then passed through a syringe filter.

The pilot manufacturing was performed using a pilot coater located at UMASS Amherst. The support membrane roll (UE50) was operated with a line speed of 6-14 ft/min. The copolymer/cross-linker solution was coated onto the support membrane web using a slot die. After coating, the web passed through an 80° C. convection oven to evaporate the solvent. The cross-linkers are expected to not evaporate in the oven and thereby be uniformly distributed throughout the dried copolymer selective layer following the solvent evaporation. UV light (>240 nm) was then shined on the entire membrane sheet to initiate the cross-linking reaction.

### INCORPORATION BY REFERENCE

All U.S. and PCT patent publications and U.S. patents mentioned herein are hereby incorporated by reference in their entirety as if each individual patent publication or patent was specifically and individually indicated to be incorporated by reference. In case of conflict, the present application, including any definitions herein, will control.

### OTHER EMBODIMENTS

Those skilled in the art will recognize or be able to ascertain using no more than routine experimentation many equivalents to the specific embodiments described herein. The scope of the present embodiments described herein is not intended to be limited to the above Description, but rather is as set forth in the appended claims. Those of ordinary skill in the art will appreciate that various changes and modifications to this description may be made without departing from the spirit or scope of the present invention, as defined in the following claims.

1. A method of making a thin film composite membrane, the method comprising:
providing a copolymer comprising (i) a plurality of zwitterionic repeat units, and (ii) a plurality of hydrophobic repeat units; wherein each hydrophobic repeat unit comprises an alkene;
providing a plurality of crosslinking units; wherein each crosslinking unit comprises a first terminal thiol moiety and a second terminal thiol moiety;
providing an initiator;
providing a solvent;
admixing the copolymer, the plurality of crosslinking units, the initiator, and the solvent, thereby forming a mixture;
coating the mixture onto a support membrane;
evaporating the solvent,
activating the initiator, thereby forming the thin film composite membrane comprising a crosslinked zwitterionic copolymer,
wherein a mass ratio of the copolymer:the initiator:the plurality of crosslinking units is about 10:1:1 to about 200:1:1.

2. The method of claim 1, wherein the solvent is methanol, acetonitrile, isopropanol, hexane, or a combination of any of them.

3. The method of claim 1, wherein the activation is performed at a room temperature.

4. The method of claim 1, wherein the initiator is a photo-initiator, redox initiator, thermal initiator, or a combination of any of them.

5. The method of claim 1, wherein the initiator is a benzoin ether, a benzil ketal, a α-dialkoxy-acetophenone, a α-hydroxyl-alkyl-phenone, a α-amino-alkyl-phenone, an acyl-phosphine oxide, a benzophenone (with or without amine synergist), a thioxanthone (with or without amine synergist), hydrogen peroxide, an alkyl peroxide, an acyl peroxide, a persulfate, a disulfide, a dibenzoyl peroxide (with or without tertiary amine synergists), a benzoyl peroxide, 1,1′-azobis(cyclohexanecarbonitrile), azobisisobutyronitrile, di-tert-butyl nitroxide, or a combination thereof.

6. The method of claim 5, wherein the initiator is 2,2-dimethoxy-2-phenylacetophenone (DPMA) or 2-hydroxy-2-methylpropiophenone.

7. The method of claim 1, wherein the crosslinking unit is an alkyl dithiol, a benzene dithiol, an ethylene glycol dithiol, a biphenyl dithiol, a multiarmed thiol, a mono-thiol, or a polymer or a copolymer that include thiols.

8. The method of claim 7, wherein the crosslinking unit is 1,6-hexanedithiol (HDT).

9. The method of claim 1, wherein the solvent is a mixture of methanol and acetonitrile.

10. The method of claim 9, wherein methanol and acetonitrile are present in about 1.5:1 to about 3:1 ratio (v/v) at about 4 to about 6 w/v %.

11. (canceled)

12. (canceled)

13. The method of claim 1, wherein a mass ratio of the copolymer:the initiator:plurality of crosslinking units is about 10:1:1 to about 100:1:1.

14. (canceled)

15. (canceled)

16. The method of claim 1, wherein an amount of the initiator is 0.01 grams to about 20 grams per gram of the copolymer.

17. (canceled)

18. (canceled)

19. The method of claim 1, wherein an amount of the plurality of crosslinking units is 0.01 grams to about 20 grams per gram of the copolymer.

20. (canceled)

21. (canceled)

22. The method of claim 1, wherein the support membrane comprises UE50, Trisep, or a combination thereof.

23. The method of claim 1, wherein the mixture is coated onto the support membrane using a wire wound rod.

24. The method of claim 1, wherein the solvent is evaporated by heating at about 50-100° C.

25. (canceled)

26. The method of claim 1, wherein the initiator is activated with UV light, or an elevated temperature, or a combination thereof.

27-32. (canceled)

33. The method of claim 1, wherein the thin film composite membrane comprises at least two layers of a porous support layer, and a layer of the crosslinked zwitterionic copolymer.

34. The method of claim 33, wherein the layer of the crosslinked zwitterionic copolymer has a thickness of about 0.1 μm to about 10 μm.

35. The method of claim 34, wherein the layer of the crosslinked zwitterionic copolymer has a thickness of about 1 μm to about 10 μm.
